(19) United States
(12) Patent Application Publication
(10) Pub. No.: US 2023/0322639 A1
(43) Pub. Date: Oct. 12, 2023

(54) AN ORGANIC AGRICULTURAL COMPOSITION

(71) Applicant: Hiteshkumar Anilkant DOSHI, Thane (IN)

(72) Inventor: Hiteshkumar Anilkant DOSHI, Thane (IN)

(21) Appl. No.: 18/044,506

(22) PCT Filed: Sep. 8, 2021
(86) PCT No.: PCT/IB2021/058164

§ 371 Date: Mar. 8, 2023

(30) Foreign Application Priority Data
Sep. 8, 2020 (IN) IN202021038734

(51) Int. Cl. C05D 9/02; C05G 5/27; C05G 5/12; C05G 3/70; C05G 3/80

(52) U.S. Cl. CPC C05D 9/02; C05G 5/27; C05G 5/12; C05G 3/70; C05G 3/80

(57) ABSTRACT

The present invention relates to an organic agricultural composition comprising at least one micronutrient in its elemental form or salts or complexes or derivatives thereof and at least one hydrocolloid, wherein the composition is in the granular or wettable powder or suspension form, and wherein the hydrocolloid has viscosity of ≤400 cps at ≤30% (w/w) aqueous dispersion of the hydrocolloid. The composition comprises particles in the size range of 0.1 to 20 microns.

The invention also relates to a process of preparing an organic agricultural composition comprising at least one micronutrient in its elemental form or salts or complexes or derivatives thereof and at least one hydrocolloid; wherein the composition is in the form of water dispersible granules or spheronised granules or wettable powder or suspension, and wherein the hydrocolloid has viscosity of ≤400 cps at ≤30% (w/w) aqueous dispersion of the hydrocolloid.

### 1. FIELD OF THE INVENTION

The present invention relates to an organic agricultural composition comprising at least one micronutrient in its elemental form or salts or complexes or derivatives thereof and at least one hydrocolloid. The present invention relates to an organic agricultural composition comprising at least one micronutrient in its elemental form or salts or complexes or derivatives thereof and at least one hydrocolloid, wherein the hydrocolloid has a viscosity of less than or equal to (≤) 400 cps at less than or equal to (≤) 30% (w/w) aqueous dispersion of the hydrocolloid. The organic agricultural composition is in the form of a granule or wettable powder or suspension and the composition comprises particles in the size range of 0.1 micron to 20 microns.

The invention further relates to a process of preparing an organic agricultural composition comprising at least one micronutrient in its elemental form or salts or complexes or derivatives thereof and at least one hydrocolloid; wherein the hydrocolloid has a viscosity of ≤400 cps at ≤30% (w/w) aqueous dispersion of the hydrocolloid; wherein the composition is in the form of a water dispersible granule or wettable powder or spheronised granule or suspension.

### 2. BACKGROUND OF THE INVENTION

In describing the embodiment of the invention, specific terminology is chosen for the sake of clarity. However, it is not intended that the invention be limited to the specific terms so selected and it is to be understood that each specific term include all technical equivalents that operate in a similar manner to accomplish a similar purpose.

Current farming practices are challenged with labor shortage, water shortage, demand on high and quality yields. Besides, deteriorating soil health, decreasing fertility of soil, leaching of fertilizers and pesticides in soil and groundwater, micronutrient deficiencies in soil pose long term challenge in farming practices.

One of the root causes of the deteriorating soil health and increasing environmental pollution is the excessive use of chemical fertilizers and pesticides. Several agrochemical agents are being used at high dosages for long periods of time as fertilizers and for countering pests and diseases. These chemical agents are a constant burden on the environment as they contaminate the soil, water, turf, and other vegetation. In addition to countering pests and diseases, they can be toxic to a host of other organisms including birds, fish, beneficial insects, and non-target plants. Most of the agrochemical agents leach into the soil and groundwater which can end up in drinking water also. The sprays can drift and pollute the air. Further nutrient losses are also a cause for concern due to the economics, as well as due to environmental reasons. Besides, agricultural produce using chemical fertilizers, pesticides, weedicides can potentially cause adverse effect on the health of people and can be corelated to disease conditions in humans.

There is a greater need today to optimize farming and agriculture practices by avoiding the use and application of synthetic chemicals, pesticides, chemical adjuvants and excipients to the soil and crops and thereby reduce the chemical residue burden on the environment.

In view of the same, there is a need to develop an agricultural fertilizer composition which is devoid of chemicals and provides suitable nutrients to the soil. Such a composition would help in reducing the chemical residue burden on the environment. Also, there is a need for a composition which besides avoiding the addition of chemicals to the soil and the crop, reduces the burden on the farmer, in terms of labor and costs, and is user friendly.

The role of micronutrients as an essential element required for growth and reproduction by plants has been long known. Micronutrient plays an important role in balancing the crop nutrition. Further, it is also known that optimum levels of nutrients are required for normal functioning and growth of the plants and any variance in the nutrient levels may cause overall crop growth and its health to decline due to either a deficiency or toxicity. Poor availability of fertilizers or nutrients to the plants results in lack of proper growth resulting in the plants becoming more susceptible to attack by pests.

Besides the low concentration of essential micronutrients in soil, one of the root causes for the deficiency is the low availability of micronutrients in its oxidized form to plant roots. Furthermore, managing nutrition of crops is difficult due to factors such as variable carbonate levels in soil, soil salinity, soil moisture, soil alkalinity, low temperature, and concentration of other elements i.e. ‘competitive microelements’ which may also affect the availability of the micronutrients and at times lead to the deficiency of the micronutrients.

Further, the ability of plants to respond to the availability of micronutrients ultimately affects human nutrition, both in terms of crop yield and the micronutrient concentration in the edible tissues. Therefore, proper nutrition is critical for optimizing the plant nutrition and metabolism, which in turn contributes to the overall crop yield and quality.

The below table outlines the essential micronutrients and the role of each micronutrient in plants and the signs of deficiency in plants.

| | Uptake by | | |
|---|---|---|---|
| | plants in | | |
| Micro- | oxidized | Role of micro- | |
| nutrients | form | nutrient in Plant | Sign of Deficiency |
| Zinc (Zn) | Zn²⁺ | 1. DNA transcription | 1. Stunted growth of |
| | | 2. Hormone balance and | leaves. |
| | | auxin activity | 2. Chlorosis |
| Manganese | Mn²⁺ | 1. Photosynthesis: | 1. Chlorosis |
| (Mn) | | chloroplast production | 2. Poor nodulation |
| | | 2. Root growth | of legume crops, |
| | | 3. Nitrogen fixation | leading to reduced |
| | | 4. Co-factor in plant | size and yields. |
| | | reactions | |
| Cobalt (Co) | Co²⁺ | Nitrogen fixation | 1. Chlorosis |
| | | | 2. Poor nodulation |
| | | | of legume crops, |
| | | | leading to reduced |
| | | | size and yields. |
| Copper (Cu) | Cu²⁺ | 1. Photosynthesis | Chlorosis |
| Molybdenum | Molybdate | 1. Build amino acids | Chlorosis |
| (Mo) | | 2. Nitrogen fixation | |
| Iron (Fe) | Fe²⁺ | 1. Chlorophyll synthesis | 1. Chlorosis |
| | (ferrous | 2. Enzyme functions | 2. Poor nodulation |
| | form) or | such as nitrogen fixation | of legume crops, |
| | Fe³⁺ | in legumes | leading to reduced |
| | (ferric | | size and yields. |
| | form) | | |
| Selenium | Selenate | 1. Plant growth | Chlorosis |
| (Se) | | 2. Increase resistance | |
| Boron (B) | Borate | 1. Required for sugar | 1. Stunted growth of |
| | anion | transport, flowering and | plants and death of |
| | | fruiting, pollen | plants. |
| | | germination, cell | 2. Chlorosis |
| | | division. | |
| | | 2. Metabolism of amino | |
| | | acids and proteins, | |
| | | carbohydrates, calcium, | |
| | | and water. | |
| | | 3. Strengthening of cell | |
| | | walls | |

Though the benefits of micronutrients are well known, its deficiency has become widespread over the past several decades in most of the agricultural areas of the world, resulting in micronutrients being indicated as a limiting factor to improved plant growth, high yield and fertilizer efficiency.

Conventional agricultural compositions are formulated using adjuvants which are either synthetic or prepared through chemical means. These synthetic adjuvants potentially contaminate the soil with undesired chemicals and poses residue related problems, soil deterioration and toxic effect on human beings. Prolonged use of chemicals deteriorates the soil health which eventually results in reduced crop yield. Further, the chemical adjuvants, surfactants, carriers, excipients that are used to formulate the presently available agricultural products can potentially have long term negative effect on the environment and contribute to ground water contamination with far reaching effects on mammalian and aquatic life.

Many of these adjuvants used in the conventional state-of-the-art fertilizers are non-biodegradable and remain in the soil for prolonged period of time, in some cases extending over few months and even years. One of the commonly used surfactants in the preparation of such agricultural compositions are lignin sulphonates. High doses of sodium lignin sulphonate have been found to cause adverse health effects in laboratory animals. In a study conducted with guinea pigs and rabbits, when sodium lignosulfonate at a 1 percent concentration was administered for a two- to six-week period, a high percentage of the animals developed ulcerative colon disease (Marcus and Watts, 1974).

While natural lignin is considered to be an important component of secondary cell walls in vascular plants and is the second most abundant plant derived organic substance, as larger volumes of fertilizers and pesticides are applied which employ synthetic lignin sulfonates, the long-term deleterious effects of such surfactants are not known or reported. Further, the sulfur atoms are introduced in irregular pattern in lignin sulfonates leading to sulfonated intermediates which are unable to enter the central metabolic pathways thereby restricting the biodegradation of lignin sulfonates. In addition, the high sulfur content of lignosulfonate can negatively affect the microbial metabolism, thereby hindering lignin degradation. (Asina et. al., Microbial treatment of industrial lignin: Successes, problems and challenges, 2017; Asina, Fnu, “Biodegradation of Lignin by Fungi, Bacteria and Laccases” (2016). Theses and Dissertations. 1864.)

Furthermore, the presently available conventional fertilizers exist in forms, which either do not solubilize or do not disperse adequately. This presents a great challenge to the user and the environment. As these compositions are not completely soluble, they leave behind a residue and thus poses a major challenge in agriculture.

Therefore, there is a need for natural fertilizer products or agricultural products that are devoid of synthetic adjuvants like lignin sulphonates, naphthalene lignin sulphonates etc. and yet provide good suspensibility and dispersibility. The use and application of natural (organic) product in farming practice should be in such a way that it not only results in achieving desired crop yield, plant growth, vitality and vigor with reduced burden on environment, but also benefits the farmer financially.

While the prior art(s) and the conventionally available product mandates use of synthetic surfactants to prepare water dispersible granules of micronutrients in order to achieve a well dispersing and suspending product, the inventors for the first time determined that the composition of the present invention can render water dispersible granules of micronutrients without the use of synthetic surfactants. The problem is even more pronounced, when water dispersible granules are made at a higher concentration of actives and a lower particle size. In such circumstances, surfactants are needed to coat a much larger surface area of micronutrient particles which need to be suspended and dispersed.

Therefore, there is a need for an agricultural product which provides suitable and adequate nutrients to the soil in a timely manner as per the physiological needs of the plant on one hand and simultaneously eliminates the use of synthetic carriers in the composition, thereby resulting in an environment and user-friendly product.

It is therefore surprising that the inventors of the present invention have succeeded in making a composition of water dispersible granules of micronutrient with a fine particle size distribution, without employing synthetic surfactants. The present composition instead uses natural materials like hydrocolloid of specific characteristics which not only provide superior physical characteristics over that of conventional products like better suspensibility, dispersibility etc. but also various other benefits to the soil and the plant ecosystem. For instance, the composition of the present invention was found to aid in the correction of soil pH and additionally support microbial action thereby facilitating the availability of micronutrient in a form that can be assimilated by the plants.

The embodiments of the present invention in addition to providing an organic agricultural composition that exhibits superior physical characteristics such as better suspensibility, dispersibility, wettability, and stability towards heat, light, temperature, and caking also assists in better uptake and assimilation of ambient nutrient present in the soil.

In addition to the significance stated above, embodiments of the present invention are quite relevant to the current farming practices as it provides an organic agricultural composition which is economical, biodegradable and environment friendly. Further, the organic agricultural composition of the present invention comprising at least one micronutrient and at least one hydrocolloid does not leave any chemical residue in the environment, and helps improve the fertility of soil and making the plants strong from inside.

### 3. SUMMARY OF THE INVENTION

The invention relates to an organic agricultural composition, comprising at least one micronutrient in its elemental form or salts or complexes or derivatives thereof and at least one hydrocolloid; wherein the hydrocolloid has a viscosity of ≤400 cps at ≤30% (w/w) aqueous dispersion of the hydrocolloid; wherein the composition comprises particles in the size range of 0.1 micron to 20 microns. The organic agricultural composition is in the form of granule or suspension or wettable powder.

The invention also relates to a process for preparing an organic agricultural composition comprising at least one micronutrient in its elemental form or salts or complexes or derivatives thereof and at least one hydrocolloid; wherein the hydrocolloid has a viscosity of ≤400 cps at ≤30% (w/w) aqueous dispersion of the hydrocolloid; wherein the composition is in the form of granule or suspension or wettable powder and the composition comprises particles in the size range of 0.1 micron to 20 microns.

The process of preparing an organic agricultural composition in the form of a water dispersible granule, comprises:
a. milling blend of at least one micronutrient in its elemental form or salts or complexes or derivatives thereof, water and at least one hydrocolloid to obtain a slurry or wet mix with a particle size of 0.1 micron to 20 microns; wherein the hydrocolloid has a viscosity of ≤400 cps at ≤30% (w/w) aqueous dispersion of the hydrocolloid; and
b. drying the wet mix to obtain the composition in the form of water dispersible granules; wherein the composition comprises of granules in size range of 0.1 to 2.5 mm.

The process of preparing an organic agricultural composition in form of spheronised granule, comprises:
a. milling blend of at least one micronutrient in its elemental form or salts or complexes or derivatives thereof, water and at least one hydrocolloid to obtain a slurry or wet mix with a particle size of 0.1 micron to 50 microns; wherein the hydrocolloid has a viscosity of ≤400 cps at ≤30% (w/w) aqueous dispersion of the hydrocolloid;
b. drying the wet mix to obtain the composition in the form of water dispersible granules; wherein the composition comprises granules in size range of 0.1 to 2.5 mm; and
c. water is added to the dry composition of step (b), the mixture is blended to obtain a wet mass, which is then extruded through an extruder to obtain extruded granules in a size range of 0.1 mm to 6 mm; or agglomerating the wet mix or dry composition of step (b) in an agglomerator to obtain composition in the form of granules, wherein the granules are in a size range of 0.1 mm to 6 mm.

The process of preparation of an organic agricultural composition in the form of suspension, comprising:
a. homogenizing mixture of at least one micronutrient in its elemental form or salts or complexes or derivatives thereof, a liquid vehicle and at least one hydrocolloid; wherein the hydrocolloid has a viscosity of ≤400 cps at ≤30% (w/w) aqueous dispersion of the hydrocolloid; and
b. wet milling the obtained suspension to provide the organic agricultural composition with a particle size range of 0.1 micron to 20 microns.

### 4. DETAILED DESCRIPTION OF THE INVENTION

In describing the embodiment of the invention, specific terminology is chosen for the sake of clarity. However, it is not intended that the invention be limited to the specific terms so selected and it is to be understood that such specific terms include all technical equivalents that operate in a similar manner to accomplish a similar purpose. It is understood that any numerical range recited herein is intended to include all subranges subsumed. Also, unless denoted otherwise percentage of components in a composition are presented as weight percent.

The terms “a” or “an”, as used herein, are defined as one or more than one. The terms “including” and/or “having”, as used herein, are defined as comprising (i.e., open language).

Granules refers mainly to water dispersible granules, extruded granules or spheronised granules or pellets. The spheronised granules also refers to broadcast granules or water disintegrable granules. The granules also refer to soluble granules. As described herein, “GR” refers to extruded granules or spheronised granules or pellets or soluble granules (SG).

A water dispersible granule is defined as a formulation which disperses or dissolves readily when added to water to give a fine particle suspension. As described herein, “WG” or “WDG” refer to water dispersible granules.

An organic suspension or ‘suspension’ encompasses, “aqueous suspension” or aqueous dispersion” or “suspension concentrate (SC)” or “suspo-emulsion” or a “liquid suspension” composition. The suspension is defined as composition wherein solid particles are dispersed or suspended in a liquid. The liquid as a vehicle can be water and/or a water miscible solvent. The water miscible solvent is environmentally safe.

As defined herein, WP refers to a wettable powder, which can be a powder formulation to be applied as a suspension after dispersion in water.

Organic agricultural composition is defined as a composition wherein, the composition comprises ingredients of natural origin or ingredients that are certifiable as organic.

Micronutrients used in the composition refers to nutrients that are needed in small amounts to achieve optimum plant growth. The micronutrients are in their elemental form or salts or complexes or derivatives thereof. The micronutrients can also be in the form of ores or derived from natural sources thereof.

Hydrocolloid used in the composition refers to substances with affinity to water and also encompasses ‘gum’. The hydrocolloids used in the composition are water-binding colloids of natural origin including botanical, animal, or microbial origin.

Hydrocolloids are long chain polymers of polysaccharides characterised by their property of forming viscous dispersions and/or gels when dispersed in water. According to an embodiment, the hydrocolloids are heterogeneous group of polysaccharides and proteins. Hydrocolloids are known in the art for its use as gelling agent, thickener or stabilizer in healthcare, personal care or food industry.

Although the use of hydrocolloids as gelling agents, thickeners or stabilizers are known in the art, it was surprisingly determined by the inventors that when the hydrocolloid has a viscosity of ≤400 cps at ≤30% (w/w) aqueous dispersion of the hydrocolloid, when combined with at least one micronutrient in its elemental form or salts or complexes or derivatives thereof exhibited unexpected nutritional effect.

Surprisingly, the inventors of the present application determined that when at least one micronutrient in its elemental form or salts or complexes or derivatives thereof is combined with at least one hydrocolloid with a viscosity of ≤400 cps at ≤30% (w/w) aqueous dispersion of the hydrocolloid, in an effective amount at a specific particle size, it demonstrates excellent suspensibility, dispersibility in water and soil moisture leading to excellent field efficacy in terms of improved yield and plant vigor.

The inventors of the present application also determined that at least one micronutrient in its elemental form or salts or complexes or derivatives thereof when combined with at least one hydrocolloid with a viscosity of ≤400 cps at ≤30% (w/w) aqueous dispersion of the hydrocolloid in an effective amount at a specific particle size demonstrates quick conversion of micronutrient to its oxidized form to be available for ready uptake by the plants. In addition, the composition comprising particles in the size range of 0.1 to 20 microns demonstrates superior suspensibility and dispersibility thereby enabling it to be applied through different means like drip and sprinkler irrigation. The micronutrients present in the composition can be applied uniformly and effectively to the soil and the plant rhizosphere thus providing better nutrient use efficiency over conventional products.

It has surprisingly been found that loading of at least one micronutrient in its elemental form or salts or complexes or derivatives thereof at an effective amount in combination with at least one hydrocolloid helped reduce the dependency on chemical adjuvants and excipients, further reducing toxicity caused to environment and humans, and avoid subsequent use of chemicals, and promote better plant health and yield.

It has surprisingly been found that when hydrocolloid with a viscosity of ≤400 cps at ≤30% aqueous dispersion of the hydrocolloid is used in an effective amount with specific concentration of at least one micronutrient, the composition of the present invention besides providing desired binding, gelling or thickening properties, exhibited unexpected improvement in dispersibility, suspensibility and emulsifying properties of the composition, thereby obviating the use of conventional dispersing agents, wetting agents, surfactants and emulsifying agents which are chemical in nature. Further, the inventors also found that the hydrocolloid provides stable structure to the composition and prevents sedimentation of the micronutrient particles after prolonged storage.

The inventors of the present invention found that hydrocolloids with a viscosity of ≤400 cps at ≤30% aqueous dispersion for granular organic agricultural composition are selected in such a way that the hydrocolloid wets micronutrient but does not form a viscous gel in water. For example, hydrocolloids like Xanthan gum, Almond gum and Katira gum cannot be used for the granular organic composition as it forms viscous gel in water at a concentration of 0.1% w/w and does not wet micronutrient. Also, hydrocolloids such as Gellan gum and Dammar gum cannot be used for the granular organic composition as it does not wet micronutrient.

Micronutrient in its elemental form or salts or complexes or derivatives thereof is an essential active ingredient present in the organic agricultural composition and used in a specific concentration in combination with at least one hydrocolloid in a specific concentration provides a more sustainable and ecological approach in agriculture for crop protection and nutrition; wherein the hydrocolloid has a viscosity of ≤400 cps at ≤30% (w/w) aqueous dispersion of the hydrocolloid. Further, the combination of at least one hydrocolloid with at least one micronutrient in its elemental form or salts or complexes or derivatives thereof attributed to enhance certain structural characteristics of the soil, including in particular its pH by shifting the pH of the soil towards neutral or acidic values for alkaline soils. The correction of pH value helps oxidize the micronutrients and thereby helps in better uptake of micronutrients by plants.

In addition to the nutritional effect of the composition of the present invention, the inventors surprisingly determined that the composition comprising at least one micronutrient in its elemental form or salts or complexes or derivatives thereof and at least one hydrocolloid in an effective amount in the form of suspension or granules provides improved plant growth and strengthens the plant, thereby prevents fungicidal and pest infections resulting in better yield; when the particles in the composition are present in the size range of 0.1 micron to 20 microns; wherein the hydrocolloid has a viscosity of ≤400 cps at ≤30% (w/w) aqueous dispersion of the hydrocolloid.

The inventors found that the composition of the present invention provides a stable organic ecological product which is a combination of at least one micronutrient and at least one hydrocolloid in an effective amount with particles in the size range of 0.1 micron to 20 microns. The granular composition is superior in nature on account of excellent suspensibility and dispersibility of the particles when the granules are immersed in water. As a consequence, the product does not exhibit clogging of nozzles which is seen in powder-based compositions or even conventional compositions that employ chemical adjuvants like lignin sulphonates.

The inventors have surprisingly found that in addition to eliminating synthetic chemical adjuvants and surfactants, the composition of the present invention also supports soil microbial activity that facilitates the availability of micronutrients in a form that can be assimilated by the plants, enhances the nutritional value of soil, and consequently, it improves and enhances the crop health.

Further, the inventors found that the composition of the present invention containing natural product, hydrocolloid, is safe for environment, humans and animals. Consequently, the composition eliminates the residual effects and toxicity problem posed by the use of the conventional chemical adjuvants and surfactants.

The inventors also found that the agricultural composition in the form of suspension or granules comprising particles in the size range of 0.1 micron to 20 microns enhances the physical nature of the formulation by providing improved suspensibility, dispersibility, viscosity, instant dispersion of micronutrients on application via soil or foliar route resulting in strengthening and fortification of crops and prevent pest and disease occurrence. The fine particle size of the composition in turn increases the surface area of micronutrient particles and also enables the product to cover wider surface area thus enabling bio-effectiveness at a substantially lower dosage.

Thus, the present invention relates to an organic agricultural composition comprising at least one micronutrient in its elemental form or salts or complexes or derivatives thereof, and at least one hydrocolloid, wherein the composition comprises particles in the size range of 0.1 to 20 microns. The hydrocolloid has viscosity of ≤400 cps at ≤30% aqueous dispersion of the hydrocolloid.

The micronutrient is selected from zinc, iron, copper, manganese, cobalt, selenium, molybdenum, boron, vanadium, silicon in its elemental form or salts or complexes or derivatives thereof. The micronutrient can also be in chelated or non-chelated form.

According to an embodiment, micronutrients such as selenium and vanadium can be present at very low concentrations, for example, as low as 0.001% in their elemental form on a weight/weight basis, depending on the dosage, deficiency and crop requirement.

According to an embodiment, the derivatives or sources of micronutrient in the composition can include minerals. The micronutrient can also be in the form of ores. The ores can be oxides; silicates, carbonate ores; sulphide ores; or halide ores. The ores can also be natural ores or direct shipping ores (DSO). For example, direct shipping ores can be ores such as iron ores comprising hematite, magnetite; manganese ore comprising pyrolusite (MnO₂) and rhodochrosite (MnCO₃). The salts of micronutrient include water soluble or water insoluble salts. However, the micronutrients listed hereinabove are exemplary and not meant to limit the scope of the invention.

According to an embodiment, the water-insoluble micronutrients comprises of
iron oxide including but not limited to ferrous oxide (FeO), ferric oxide (Fe₂O₃), Ferroso ferric oxide (Fe₃O₄) black iron oxide; iron tartrate, iron hydroxide including but limited to ferric hydroxide (Fe(OH)₃), iron hydroxide (III), iron oxyhydroxide, iron rust, and limonite; iron phosphate including but not limited to ferric phosphate, ferric phosphate dihydrate, ferric phosphate hydrate, iron fumarate including but not limited to ferrous fumarate and ferro fumarate; iron succinate including but not limited to Ferrous succinate and Succinic acid iron(II) salt; carbonyl iron, iron silicates, iron carbonates.
manganese oxide, trimanganese tetraoxide or mango-manganic oxide or Hausmannite; manganese hydroxide, manganese phosphate, manganese phosphate heptahydrate, carbonyl manganese, manganese dioxide, manganese diselenide, manganese tetroxide, manganese carbonate, manganese molybdate, manganese selenide, manganese telluride, manganese titanate, manganese nitride, manganese oxalate, manganese borate, Manganese sulfide, dimanganese trioxide, their complexes, derivatives thereof and mixtures thereof; Manganese oxide includes Manganese(II) oxide, MnO (Ferrite Grade); Manganese(II,III) oxide, Mn₃O₄; Manganese(III) oxide, Mn₂O₃; Manganese dioxide, (manganese(IV) oxide), MnO₂; Manganese(VI) oxide, MnO₃; and Manganese(VII) oxide, Mn₂O₇, Manganese hydroxide includes manganese dihydroxide and Manganous hydroxide. Manganese phosphate includes Manganese (II) Phosphate, Manganese diphosphate and Manganese phosphate tribasic; Manganese dioxide includes manganese (IV) oxide, manganese peroxide, manganese black, battery manganese, pyrolusite and manganese superoxide.
calcium borate; zinc borate; magnesium borate or boracite; colemanite; aluminium borate; boron phosphate; boron trioxide or diboron trioxide; elemental boron, boron nitride, boron carbide; aluminum dodecaboride;
Zinc Oxide, Zinc carbonate, Zinc molybdate, Zinc phosphate, zinc borate, zinc silicate.
Cobalt oxide, Cobalt carbonate, Cobalt silicate, Cobalt sulphide.
Copper oxalate, Copper salts of carboxylic acids, such as citric, succinic, tartaric acid, Copper oxide, Copper hydroxide, Copper molybdate, Copper phosphate, cupric oxide, cuprous oxide, copper hydroxide, copper octanoate, copper oxychloride. copper-lime mixtures, copper linoleate, copper oleate.
Molybdenum acetate, molybdenum trioxide, Molybdenum oxide, Molybdenum carbonate, Molybdenum silicate, calcium molybdate, molybdenum zinc oxide, molybdenum dioxide, molybdenum sulphide, molybdenum disulphide, molybdenum chloride, molybdenum dichloride, molybdenum trichloride, molybdenum pentachloride.
Selenium carbonates, selenium oxides, selenium silicates
Vanadium (IV) oxide, and vanadium (III) oxide
Silicon dioxide

According to an embodiment, the water-soluble micronutrients comprises:
iron sulphate including but limited to ferrous sulfate, ferric sulphate, Green vitriol, Iron vitriol, Copperas, Melanterite, Szomolnokite, ferrous sulphate monohydrate and/or heptahydrate; iron citrate including but limited to Ferric citrate, ferric citrate anhydrous, ferric citrate dihydrate, ferric citrate hydrate, ferric citrate iron(+3) salt, ferric citrate trihydrate, ferric-citric acid and iron(III) citrate; iron carbonate, iron silicate, iron ascorbate including but not limited to Ferrous ascorbate; (+)-Iron(II) L-ascorbate; and Vitamin C iron(II) salt; iron chelate; iron sucrose; iron gluconate, iron dextran, iron chelates.
manganese acetate, manganese diacetate, manganese gluconate, manganese succinate, manganese fumarate, manganese chloride including manganese dichloride, dimanganese trioxide, manganese sulfate, manganous sulfate monohydrate, manganese chelate, manganese citrate, manganese bicarbonate, manganese zinc ferrite, sodium manganate
diborates, triborates, tetraborates and hexaborides, boric acid or orthoboric acid or boracic acid or acidum boricum; borax or sodium borate or sodium tetraborate or sodium borosilicate including its hydrated form, derivatives; or sodium tetraborate decahydrate or disodium tetraborate; disodium tetraborate octahydrate; potassium tetraborate; sodium tetraborate decahydrate; boron sesquioxide or boric acid anhydride; sodium perborate; disodium octaborate tetrahydrate or Aquabor/Boron sodium oxide or Sodium octaborate or Tim-bor insecticide or Polybor including its hydrated form, derivatives; Borax pentahydrate or Bor 48 or 5 Mol Borax; boron oxide which includes boron suboxide or boron monoxide; boron hydroxide, Sodium-Calcium Borates, boric oxide; disodium octaborate, calcium borogluconate; sodium pentaborate; ammonium pentaborate, ulexite, hydrated forms of Bordeaux mix
Zinc Sulphate, Zinc Sulphate monohydrate, Zinc Sulphate heptahydrate, Zinc Chelate, Zinc oxysulfate, Zinc chloride, Eugenol chelated Zinc, Zinc glycine, Zinc carbohydrate, Zinc sucrate, Zinc acetate, Zinc gluconate, Zinc polyflavonoid, Zinc glucoheptonate, Zinc phenolate.
Cobalt sulphate, Cobalt sulphide, Cobalt molybdate, cobaltous sulphate monohydrate, cobaltous sulphate heptahydrate
Copper Sulphide, Cupric sulphide, copper selenide, copper sulfate, basic cupric carbonate, basic cupric carbonate monohydrate, copper oxysulfate, and cuprous chloride, tribasic copper sulfate, Bordeaux mixture, copper sulfate pentahydrate
sodium molybdate, Molybdenum sulphates, ammonium molybdate, ammonium paramolybdate.
Selenium sulphide, selenide, sodium selenite, sodium selenate, selenium sulphate, selenium dioxide.
Vanadium pentoxide, ammonium metavanadate.
sodium silicate

According to an embodiment the micronutrient in the composition can also be in the form of minerals:
Iron ores: Roaldite, Taenite, Wüstite, Magnetite, Hematite, Troilite, Goethite, Greigite, Limonite, Siderite, Pyrite (Marcasite), Bernalite, Greenalite
Zinc ores: Periclase; Danbaite; Ashoverite; Sphalerite; Wurtzite.
Copper ores: Cuprite; Chalcocite; Digenite; Covellite; Bornite.
Manganese ores: Braunite; Pyrolusite; Manganite; Bixbyite, Scacchite, Kempite.
Vanadium ores: Karelianite; Paramontroseite; shcherbinaite, munirite, metamunirite
Boron ores: Aristarainite; Preobrazhenskite; Ameghinite; kaliborite; Borax; Barberiite
Selenium ores: Ferroselite, Dzharkenite; Downeyite; Achávalite.
Silicon ores: silica sand

Preferably, the micronutrient is at least one of zinc, iron, copper, manganese, cobalt, selenium, molybdenum, boron, vanadium, silicon in its elemental form, salts or complexes or derivatives thereof.

More preferably, the micronutrient is at least one of Vanadium, Manganese, Iron, Zinc, Boron, Copper, selenium in its elemental form, salts or complexes or derivatives thereof.

More preferably, the micronutrient is at least one of zinc, iron, boron, selenium in its elemental form, salts or complexes or derivatives thereof.

More preferably, the micronutrient is at least one of manganese, vanadium in its elemental form, salts or complexes or derivatives thereof.

However, the above list of micronutrients is exemplary and not meant to limit the scope of the invention.

The hydrocolloid used in the organic agricultural composition is selected such that the aqueous dispersion of the hydrocolloid at a concentration of ≤30% has a viscosity of less than or equal to 400 cps. For instance, the hydrocolloid is selected such that when 30 grams of the hydrocolloid is dispersed in 70 grams of water, the dispersion has a viscosity of equal to or less than 400 cps. The viscosity of hydrocolloids at ≤30% aqueous dispersion of the hydrocolloid is measured by Brookfield viscometer for instance. The inventors also found that the composition of micronutrient in its elemental form or salts or complexes or derivatives thereof with hydrocolloids at a concentration of ≤30% (w/w) having viscosity of less than or equal to 400 cps does not result in gelation or formation of a sticky mass during milling. As a consequence, the milled composition can be dried to obtain agglomerated particles i.e. water dispersible granules.

The hydrocolloid used in the organic agricultural composition are water-binding colloids of natural origin including botanical, animal, or microbial origin.

The hydrocolloid used in the organic agricultural composition is anionic, cationic, non-ionic, amphoteric or hydrophobic hydrocolloid.

The hydrocolloid used in the organic agricultural composition also possesses emulsification properties.

According to an embodiment the hydrocolloids have the ability to reduce the surface tension of water and thereby enhances the wettability of micronutrients.

According to an embodiment the hydrocolloids comprises gum arabic, gum karaya, gum ghatti (gum dhawada), larch gum, collagen (fish), welan gum, Albizia gum, Abelmoschus gum, Bhara gum, Cashew gum, Cordio gum, Grewia gum, Hakea gum, Khaya gum, Katira gum, Kondagogu gum, Leucaena, seed gum, Malva nut gum, Mucuna gum, Moringa gum, Neem gum, Sesbanic gum, or mixtures thereof. Preferably, the hydrocolloid is anionic hydrocolloid selected from gum arabic, gum karaya, gum ghatti, neem gum and moringa gum. However, the above list of hydrocolloids is exemplary and not meant to limit the scope of the invention.

The organic agricultural composition comprises particles in the size range of 0.1 micron to 20 microns. The inventors of the present invention determined that uptake of micronutrient is better when micronutrients are available to the crops at a particle size range of about 0.1 to 20 microns. Thus, the particle size range of 0.1 to 20 microns of the organic agricultural composition was found to be important not only in terms of ease of application but also in terms of efficacy.

The organic agricultural composition is in the form of granules or suspension or wettable powder.

The granular organic agricultural composition is in the form of either water dispersible granules, extruded granules, spheronised granules, soluble granules or pellets.

The organic agricultural composition has granules in the size range of 0.1 mm to 6 mm which disperses into particles in the size range of 0.1 micron to 20 microns.

According to an embodiment, wherein the organic agricultural composition is in the form of granules, the composition comprises at least one micronutrient in its elemental form or salts or complexes or derivatives thereof in the range of 0.001% w/w to 95% w/w of the total composition, and at least one hydrocolloid in the range of 0.1% w/w to 40% w/w of the total composition; wherein the hydrocolloid has a viscosity of ≤400 cps at ≤30% (w/w) aqueous dispersion of the hydrocolloid and the composition comprises particles in the size range of 0.1 micron to 20 microns.

According to a further embodiment, at least one micronutrient is present in the range of 0.001% w/w to 95% w/w of the total composition. According to a further embodiment, at least one micronutrient is present in the range of 0.001% w/w to 90% w/w of the total composition. According to a further embodiment, at least one micronutrient is present in the range of 0.001% w/w to 80% w/w of the total composition. According to a further embodiment, at least one micronutrient is present in the range of 0.001% w/w to 70% w/w of the total composition. According to a further embodiment, at least one micronutrient is present in the range of 0.001% w/w to 60% w/w of the total composition. According to a further embodiment, at least one micronutrient is present in the range of 0.001% w/w to 50% w/w of the total composition. According to a further embodiment, at least one micronutrient is present in the range of 0.001% w/w to 40% w/w of the total composition. According to a further embodiment, at least one micronutrient is present in the range of 0.001% w/w to 30% w/w of the total composition. According to a further embodiment, at least one micronutrient is present in the range of 0.001% w/w to 20% w/w of the total composition. According to a further embodiment, at least one micronutrient is present in the range of 0.001% w/w to 10% w/w of the total composition.

According to a further embodiment, at least one hydrocolloid is present in the range of 0.1% w/w to 40% w/w of the total composition. According to a further embodiment, at least one hydrocolloid is present in the range of 0.1% w/w to 30% w/w of the total composition. According to a further embodiment, at least one hydrocolloid is present in the range of 0.1% w/w to 20% w/w of the total composition. According to a further embodiment, at least one hydrocolloid is present in the range of 0.1% w/w to 10% w/w of the total composition.

According to an embodiment, wherein the organic agricultural composition is in the form of suspension, the composition comprises at least one micronutrient in its elemental form or salts or complexes or derivatives thereof in the range of 0.001% w/w to 70% w/w of the total composition, and at least one hydrocolloid in the range of 0.1% w/w to 30% w/w of the total composition; wherein the hydrocolloid has a viscosity of ≤400 cps at ≤30% (w/w) aqueous dispersion of the hydrocolloid and the composition comprises particles in the size range of 0.1 micron to 20 microns.

According to a further embodiment, at least one micronutrient is present in the range of 0.001% w/w to 70% w/w of the total composition. According to a further embodiment, at least one micronutrient is present in the range of 0.001% w/w to 60% w/w of the total composition. According to a further embodiment, at least one micronutrient is present in the range of 0.001% w/w to 50% w/w of the total composition. According to a further embodiment, at least one micronutrient is present in the range of 0.001% w/w to 40% w/w of the total composition. According to a further embodiment, at least one micronutrient is present in the range of 0.001% w/w to 30% w/w of the total composition. According to a further embodiment, at least one micronutrient is present in the range of 0.001% w/w to 20% w/w of the total composition. According to a further embodiment, at least one micronutrient is present in the range of 0.001% w/w to 10% w/w of the total composition.

According to a further embodiment, at least one hydrocolloid is present in the range of 0.1% w/w to 30% w/w of the total composition. According to a further embodiment, at least one hydrocolloid is present in the range of 0.1% w/w to 20% w/w of the total composition. According to a further embodiment, at least one hydrocolloid is present in the range of 0.1% w/w to 10% w/w of the total composition.

According to an embodiment, the hydrocolloid has a viscosity of ≤400 cps at ≤30% (w/w) aqueous dispersion of the hydrocolloid. According to a further embodiment, the hydrocolloid has a viscosity of ≤300 cps at ≤30% (w/w) aqueous dispersion of the hydrocolloid. According to a further embodiment, the hydrocolloid has a viscosity of ≤200 cps at ≤30% (w/w) aqueous dispersion of the hydrocolloid. According to a further embodiment, the hydrocolloid has a viscosity of ≤100 cps at ≤30% (w/w) aqueous dispersion of the hydrocolloid.

According to a further embodiment, the organic agricultural composition comprises particles in the size range of 0.1 microns to 20 microns. According to a further embodiment, the organic agricultural composition comprises particles in the size range of 0.1 microns to 15 microns. According to a further embodiment, the organic agricultural composition comprises particles in the size range of 0.1 microns to 10 microns.

According to a further embodiment, the organic agricultural composition comprises particles with a particle size distribution (D90) of less than 15 microns, and particle size distribution (D50) of less than 10 microns.

According to an embodiment, the organic agricultural composition is in the form of spheronised granules, wherein the granules are in the size range of 0.1 to 6 mm, preferably in the size range of 0.1 to 5 mm, preferably in the size range of 0.1 to 4 mm, preferably in the size range of 0.1 to 3 mm, preferably in the size range of 0.1 to 2.5 mm. The granules disperse into particles in the size range of 0.1 micron to 20 microns.

According to an embodiment, the organic agricultural composition is in the form of water dispersible granules, wherein the granules are in the size range of 0.1 to 2.5 mm, preferably in the size range of 0.1 to 2 mm, preferably in the size range of 0.1 to 1.5 mm, preferably in the size range of 0.1 to 1 mm, preferably in the size range of 0.1 to 0.5 mm. The granules disperse into particles in the size range of 0.1 micron to 20 microns.

According to an embodiment, the organic agricultural composition further comprises at least one additional active ingredient in the range of 0.1-70% by weight of the total composition and is selected from biostimulants, plant growth regulator, pesticidal actives and/or fertilizer or mixtures thereof.

According to an embodiment, the organic agricultural composition further comprises elemental sulphur. According to a further embodiment, the composition comprises elemental sulphur in the range of 0.1 to 70% w/w.

According to an embodiment, the plant growth promoter can further comprise humic acid, ascorbic acid, fulvic acid, lactic acid, oxalic acid, phytic acid, fumaric acid, gibberellin, auxins, citric acid, or mixtures thereof. However, the above list of plant growth promoter is exemplary and not meant to limit the scope of the invention.

According to an embodiment, the organic agricultural composition can further optionally comprise at least one agrochemically acceptable excipient selected from structuring agents, surfactants including organic surfactants, binders or binding agents, disintegrating agents, fillers or carriers or diluents, spreading agents, coating agents, buffers or pH adjusters or neutralizing agents, anticaking agents, antifoaming agents or defoamers, penetrants, preservatives, stabilizers, pigments, colorants, structuring agents, chelating or complexing or sequestering agents, anti-settling agents, thickeners, suspending agents or suspension aid agents, viscosity modifiers, tackifiers, humectants, rheology modifiers, sticking agents, anti-freezing agent or freeze point depressants, solvents, water soluble inerts and mixtures thereof. However, those skilled in the art will appreciate that it is possible to utilize additional agrochemically acceptable excipients without departing from the scope of the present invention.

According to an embodiment, the organic agricultural composition in the form of granules can further optionally comprise at least one agrochemical excipient selected from wetting agents, surfactant including organic surfactants, emulsifiers, wetting agents, dispersing agents, binders or fillers or carriers or diluent, disintegrating agent, buffer or pH adjuster or neutralizing agent, antifoaming agent, anti-settling agents, anticaking agent, penetrating agent, sticking agent, tackifier, pigments, colorants, stabilizers, water soluble inerts, and mixtures thereof. However, those skilled in the art will appreciate that it is possible to utilize additional agrochemically acceptable excipients without departing from the scope of the present invention.

According to an embodiment, the organic agricultural suspension can further optionally comprise at least one agrochemical excipient selected from one structuring agent, surfactants including organic surfactants, humectants, solvents, water miscible solvents, spreading agent, suspending agents or suspension aid or anti-settling, penetrating agent, sticking agents, drift reducing agents, preservatives, stabilizers, buffers or pH adjusters or neutralizing agents, antifreezing agent or freeze point depressants, antifoaming agents. However, those skilled in the art will appreciate that it is possible to utilize additional agrochemically acceptable excipients without departing from the scope of the present invention.

According to an embodiment, the agrochemically acceptable excipient is present in the range of 0.1% w/w to 90% w/w of the total composition.

According to a further embodiment, the agrochemically acceptable excipient is present in an amount of 0.1% to 90% w/w of the total composition. According to a further embodiment, the agrochemically acceptable excipient is present in an amount of 0.1% to 80% w/w of the total composition. According to an embodiment, the agrochemically acceptable excipient is present in an amount of 0.1% to 70% w/w of the total composition. According to a further embodiment, the agrochemically acceptable excipient is present in an amount of 0.10% to 60% w/w of the total composition. According to a further embodiment, the agrochemically acceptable excipient is present in an amount of 0.10% to 50% w/w of the total composition. According to a further embodiment, the agrochemically acceptable excipient is present in an amount of 0.10% to 40% w/w of the total composition. According to an embodiment, the agrochemically acceptable excipient is present in an amount of 0.1% to 30% w/w of the total composition. According to a further embodiment, the agrochemically acceptable excipient is present in an amount of 0.1% to 20% w/w of the total composition. According to a further embodiment, the agrochemically acceptable excipient is present in an amount of 0.10% to 10% w/w of the total composition.

According to an embodiment, the term ‘organic surfactant’ refers to surfactants that are of natural origin or are certifiable as organic.

According to a further embodiment, the organic surfactant further comprises saponins such as Shikakai, Horse-chestnut, Oat, Sugar beet (leaves), Quinoa, Chickpea, Saffron crocus, Soybean, Licorice, Ivy, Alfalfa, Chinese ginseng, American ginseng, Green pea, Milkwort, Primula, Quillaja bark (LATAM), Reetha, Soapwort, Sarsaparilla, Fenugreek, soap nut, aritha, or Yucca as an extract or powdered form thereof. However, the above list of organic surfactants and saponins are exemplary and not meant to limit the scope of the invention. Further, those skilled in the art will appreciate that it is possible to utilize other conventionally known organic surfactants without departing from the scope of the present invention. The organic surfactants are commercially manufactured and available through various companies.

According to a further embodiment, the composition can comprise natural diluents. According to a further embodiment, natural diluents can comprise water soluble substances. For example, natural diluents comprise water soluble minerals or salts such as sulphates of sodium or potassium, or sodium chloride, or potassium chloride.

According to an embodiment, the binding agents or binders which are used in the organic agricultural composition, comprises one or more of lactose, water soluble cellulose derivatives, starch, dextrins, bentonite, carbohydrates such as monosaccharides, disaccharides, oligosaccharides and polysaccharides, clays, kaolin clay, attapulgite clay their derivatives and combinations thereof. However, those skilled in the art will appreciate that it is possible to utilize different binding agents without departing from the scope of the present invention. The binding agents are organic in nature or certifiable as organic and are commercially manufactured and available through various companies.

According to an embodiment, the carriers which are used in the organic agricultural composition include, but are not limited to one or more of solid carriers or fillers or diluents. According to another embodiment, the carriers include mineral carriers, plant carriers, water-soluble carriers. However, those skilled in the art will appreciate that it is possible to utilize different carriers without departing from the scope of the present invention. The carriers are commercially manufactured and available through various companies.

The solid carriers include clay such as bentonite, clay, dolomite, kaolin, diatomaceous silicas, talc, natural silicates, starch, modified starch (Pineflow, available from Matsutani Chemical industry Co., Ltd.), plant carriers such as cellulose, starch, sucrose, Lactose, maltodextrin and dextrin. Water insoluble carriers include, but not limited to clays, microcrystalline cellulose, volcanic ash, diatomaceous earth, soap stone, starch. However, those skilled in the art will appreciate that it is possible to utilize different solid carriers without departing from the scope of the present invention. The solid carriers are commercially manufactured and available through various companies.

According to an embodiment, the anticaking agents which are used in organic agricultural composition include, but are not limited to one or more of silica, perlite, mica, talc, soapstone, clays, ester gum, or derivatives thereof. However, those skilled in the art will appreciate that it is possible to utilize different anticaking agents without departing from the scope of the present invention. The anticaking agents are commercially manufactured and available through various companies.

According to an embodiment, the antifoaming agents or defoamers which are used in the composition include, but not limited to one or more of silica, silicon-dioxide, vegetable oils, petroleum oils, paraffin oil, or derivatives thereof. However, those skilled in the art will appreciate that it is possible to utilize other conventionally known antifoaming agents without departing from the scope of the present invention. The antifoaming agents are commercially manufactured and available through various companies.

According to an embodiment, the sticking agents which are used in the composition include, but not limited to one or more of mineral oils, vegetable oils, petroleum oil, emulsifiers, fish oil or fatty acid soaps or emulsified vegetable oil, cellulose derivatives, natural polymers like xanthan gum. However, those skilled in the art will appreciate that it is possible to utilize other conventionally known sticking agents without departing from the scope of the present invention.

According to an embodiment, the preservatives which are used in the organic agricultural composition include but not limited to, one or more of bactericides, anti-fungal agents, biocides, anti-microbial agents, and antioxidant. Non-limiting examples of preservatives include one or more of potassium Sorbate, potassium benzoate, sodium benzoate, paraben, salts or derivatives thereof. However, those skilled in the art will appreciate that it is possible to utilize other conventionally known preservatives without departing from the scope of the present invention.

The preservatives are commercially manufactured and available through various companies.

According to an embodiment, the structuring agents which are used in the organic agricultural composition include, but not limited to one or more of thickeners, viscosity modifiers, tackifiers, suspension aids, rheological modifiers or anti-settling agents. The structuring agents comprises one or more of xanthan gum, metal silicates, methylcellulose, polysaccharide, alkaline earth metal silicate, bentonite, attapulgite, kaolin or polyvinyl alcohol. The structuring agents are commercially manufactured and available through various companies. However, those skilled in the art will appreciate that it is possible to utilize other conventionally known structuring agents without departing from the scope of the present invention.

According to an embodiment, the antifreezing agents or freezing point depressants used in the aqueous suspension composition include, but are not limited to one or more of polyhydric alcohols such as, propylene glycol, glycerol, glycol ethers, glycol monoethers, carbohydrates such as fructose, galactose, sucrose, lactose, maltose, xylose, arabinose, trehalose, raffinose or derivatives thereof. However, those skilled in the art will appreciate that it is possible to utilize different antifreezing agents without departing from the scope of the present invention. The antifreezing agents are commercially manufactured and available through various companies.

According to an embodiment, the chelating or complexing or sequestering agents which are used in the aqueous suspension composition include, but not limited to one or more of α-hydroxy acids, such as citric acid; fulvic acid, cyclodextrin, humic acid. However, those skilled in the art will appreciate that it is possible to utilize other chelating or complexing or sequestering agents without departing from the scope of the present invention. The chelating or complexing or sequestering agents are commercially manufactured and available through various companies.

According to an embodiment, the penetrant which is used in the aqueous suspension composition include, but not limited to one or more of alcohol, glycol, etc. However, those skilled in the art will appreciate that it is possible to utilize different penetrants without departing from the scope of the present invention. The penetrants are commercially manufactured and available through various companies.

According to an embodiment, the humectant is selected from, but not limited to one or more of propylene glycol, glycerol, and the like. However, those skilled in the art will appreciate that it is possible to utilize other conventionally known humectants without departing from the scope of the present invention. The humectants are commercially manufactured and available through various companies.

It has been surprisingly found that the organic agricultural composition of the present invention has enhanced and improved physical properties of dispersibility, suspensibility, wettability, viscosity, pourability, and provides ease of handling and also reduces the loss of material while handling the product at the time of packaging as well as during field application.

Wettability is the condition or the state of being wettable and can be defined as the degree to which a solid is wetted by a liquid, measured by the force of adhesion between the solid and liquid phases. The wettability of the granular composition is measured using the Standard CIPAC Test MT-53 which describes a procedure for the determination of the time of complete wetting of wettable formulations. A weighed amount of the granular composition is dropped on water in a beaker from a specified height and the time for complete wetting was determined. According to another embodiment, the organic agricultural composition in the form of water dispersible granules or spheronised granules has wettability of less than 2 minutes.

The spheronised granular composition is formulated in a manner such that it is imparted with sufficient hardness which prevents the granules from crumbling during storage and transportation. The hardness exhibited by the granules can be estimated by hardness testers such as the ones provided by Shimadzu, Brinell Hardness (AKB-3000 Model), Mecmesin, Agilent, Vinsyst, Ametek, Erweka, Electrolab, Dr. Schleuniger's pharmatron and Rockwell. According to an embodiment, the hardness exhibited by the granules is at least 1 Newton.

According to an embodiment, the organic agricultural composition in the form of water dispersible granule or suspension passes the wet sieve retention test. The test is used to determine the amount of non-dispersible material in formulations that are applied as dispersions in water. The wet sieve retention value of the agrochemical composition in the form of suspension and granules is measured by using the Standard CIPAC Test MT-185 which describes a procedure for the measuring the amount of material retained on the sieve. A sample of the formulation is dispersed in water and the suspension formed is transferred to a sieve and washed. The amount of the material retained on the sieve is determined by drying and weighing

According to an embodiment, the organic agricultural composition in the form of water dispersible granule or suspension has a wet sieve retention value on a 75-micron sieve of less than 0.5%. According to an embodiment, the organic agricultural composition has a wet sieve retention value on a 75-micron sieve of less than 0.2%. The wet sieve retention value of less than 0.5% indicate that the organic agricultural composition helps in easy application of the formulation preventing clogging of the nozzles or filter equipment.

According to an embodiment, the organic agricultural composition in the form of suspension does not sediment or settle on storage and is easily pourable. This property can be measured in terms of viscosity of the fluid which is a measure of its resistance to gradual deformation by shear stress or tensile stress.

According to an embodiment, viscosity of the liquid composition is determined as per CIPAC MT-192. A sample is transferred to a standard measuring system. The measurement is carried out under different shear conditions and the apparent viscosities are determined. During the test, the temperature of the liquid is kept constant. According to a further embodiment, the organic agricultural composition has a viscosity at 25° C. of about 10 cps to about 3000 cps.

According to an embodiment, the suspension composition of the present invention is easily pourable. The pourability is the measure of percent of residue. According to an embodiment, the pourability of the organic agricultural composition is determined as per CIPAC MT-148.1 by allowing the suspension to stand for 24-hour and the amount remaining in the container after a standardized pouring procedure is determined. The container is rinsed and the amount then remaining is determined and the maximum residue in percent is calculated. According to a further embodiment, the pourability of the organic agricultural composition is less than 5% residue.

Dispersibility of the organic agricultural composition in the form of water dispersible or spheronised granule and suspension is a measure of percent dispersion. Dispersibility is calculated by the minimum percent dispersion. Dispersibility is defined as the ability of the granules to disperse upon addition to a liquid such as water or a solvent. Dispersibility of the granular composition of the present application, was determined as per the standard CIPAC test, MT 174. A known amount of the granular composition was added to a defined volume of water and mixed by stirring to form a suspension. After standing for a short period, the top nine-tenths are drawn off and the remaining tenth dried and determined gravimetrically. The method is virtually a shortened test of suspensibility and is appropriate for establishing the ease with which the granular composition dispersed uniformly in water.

According to an embodiment, the organic agricultural composition has a dispersibility of at least 30%.

According to an embodiment, the organic agricultural composition in the form of water dispersible granule exhibits almost instantaneous dispersion.

According to an embodiment, the organic agricultural composition in the form of spheronised granule makes the actives available instantaneously and also over a longer period which may extend throughout the crop cycle, providing an immediate and sustained release of actives eventually strengthening and protecting the crop at each and every stage of the crop cycle.

According to an embodiment, the organic agricultural composition in the form of granules or suspension exhibits good suspensibility. Suspensibility is defined as the amount of active ingredient suspended after a given time in a column of liquid, of stated height, expressed as a percentage of the amount of active ingredient in the original suspension. The water dispersible granules can be tested for suspensibility as per the CIPAC Handbook, “MT 184 Test for Suspensibility” whereby a suspension of known concentration of the composition in CIPAC Standard Water was prepared and placed in a prescribed measuring cylinder at a constant temperature, and allowed to remain undisturbed for a specified time. The top 9/10ths were drawn off and the remaining 1/10th was then assayed chemically, gravimetrically, or by solvent extraction, and the suspensibility was calculated.

The suspensibility of the suspension is the amount of active ingredient suspended after a given time in a column of liquid, of stated height, expressed as a percentage of the amount of active ingredient in the original suspension. The suspensibility of suspension concentrate is determined as per CIPAC MT-161 by preparing 250 ml of diluted suspension, allowing it to stand in a measuring cylinder under defined conditions, and removing the top nine-tenths. The remaining tenth is then assayed chemically, gravimetrically or by solvent extraction, and the suspensibility is calculated.

According to an embodiment, the organic agricultural composition has a suspensibility of at least 30%.

According to an embodiment, the organic agricultural composition in the form of water dispersible granule or spheronised granule, suspension demonstrates superior stability in terms of suspensibility under accelerated storage condition (ATS). According to an embodiment, the organic agricultural composition demonstrates suspensibility of at least 30% under ATS.

According to an embodiment, the organic agricultural composition demonstrates superior stability towards heat, light, temperature and caking. The composition does not form a hard cake and exhibits enhanced stability even at extended storage under higher temperatures which in turn results in superior field performance. According to a further embodiment, the stability exhibited by the organic agricultural composition is at least 6 months.

In describing the below embodiments of the invention, it will be observed that numerous modifications and variations can be effectuated in the process for preparation of organic agricultural composition without departing from the true spirit and scope of the novel concepts of the present invention. It is to be understood that no limitation with respect to the specific embodiments illustrated below is intended or should be inferred.

According to an embodiment, the present invention also relates to a process of preparing organic agricultural composition comprising at least one micronutrient in its elemental form or salts or complexes or derivatives thereof and at least one hydrocolloid in the form of granules or suspension, wherein the composition has particles in the size range of 0.1 micron to 20 microns; wherein the hydrocolloid has viscosity of ≤400 cps at ≤30% (w/w) aqueous dispersion of the hydrocolloid.

According to an embodiment, the process of preparing organic agricultural composition in granular form, comprising at least one micronutrient in its elemental form or salts or complexes or derivatives thereof present in the range of 0.001% w/w to 95% w/w of the total composition, at least one hydrocolloid present in the range of 0.1% w/w to 40% w/w of the total composition; wherein the composition has particles in the size range of 0.1 micron to 20 microns; wherein the hydrocolloid has viscosity of ≤400 cps at ≤30% (w/w) aqueous dispersion of the hydrocolloid. The granular organic agricultural composition is in the form of either water dispersible granules, soluble granules, extruded granules, spheronised granules or pellets.

According to an embodiment, the process of preparing organic agricultural composition in the form of suspension, comprising at least one micronutrient in its elemental form or salts or complexes or derivatives thereof present in the range of 0.001% w/w to 70% w/w of the total composition, and at least one hydrocolloid present in the range of 0.1% w/w to 30% w/w of the total composition; wherein the composition has particles in the size range of 0.1 micron to 20 microns; wherein the hydrocolloid has viscosity of ≤400 cps at ≤30% (w/w) aqueous dispersion of the hydrocolloid.

According to another embodiment, the organic agricultural composition in the form of water dispersible granules or spheronised granules, is made by various techniques such as spray drying, fluidized bed granulation, pan granulation, pin agglomerator, spheronizer, freeze drying etc. The granules can also be extruded through the extruded to obtain extruded granules.

According to an embodiment, the process of preparing a water dispersible granular organic agricultural composition involves milling a blend of at least one micronutrient in its elemental form or salts or complexes or derivatives thereof, water and at least one hydrocolloid to obtain slurry or a wet mix. The wet mix obtained is then dried, for instance in a spray dryer, fluid bed dryer or any suitable granulating equipment, followed by sieving to remove the undersized and oversized granules to obtain water dispersible granules of the desired size if required. However, those skilled in the art will appreciate that it is possible to modify or alter or change the process or process parameters to obtain water dispersible granular composition without departing from the scope of the present invention. Water is added to the obtained dried composition and the mixture is blended to obtain a wet mass, which is then extruded through an extruder to obtain the granules of desired size. The wet mass as referred herein also includes dough or paste. The granules can also be formed with hot melt extrusion. However, those skilled in the art will appreciate that it is possible to modify or alter or change the process or process parameters to obtain granular composition without departing from the scope of the present invention.

The granules obtained from the granulator can also be dried in open air or air-dried, to remove any residual moisture, if any. However, those skilled in the art will appreciate that it is possible to modify or alter or change the process or process parameters without departing from the scope of the present invention.

According to another embodiment, the invention further relates to the process for preparing the spheronised granules which involves milling a blend of at least one micronutrient in its elemental form or salts or complexes or derivatives thereof, water and at least one hydrocolloid to obtain slurry or a wet mix. The wet mix obtained is then dried, for instance in a spray dryer, fluid bed dryer or any suitable granulating equipment, followed by sieving to remove the undersized and oversized granules to obtain granules. The powder or the fine granules is further subjected to agglomeration in an agglomerator to obtain granules of size 0.1 mm to 6 mm. The agglomerator can include various equipments such as a disc pelletizer or pan granulator, pin agglomerator, spheronizer, or combinations thereof.

According to another embodiment, the invention relates to a process for preparing the organic agricultural suspension composition.

According to an embodiment, the process of preparation of the organic agricultural composition in the form of suspension, comprises: homogenizing mixture of at least one micronutrient in its elemental form or salts or complexes or derivatives thereof, a liquid vehicle and at least one hydrocolloid to obtain a suspension; and wet milling the obtained suspension to provide composition with a particle size range of 0.1 micron to 20 microns; wherein the hydrocolloid has viscosity of ≤400 cps at ≤30% (w/w) aqueous dispersion of the hydrocolloid. The liquid vehicle is selected from water and/or a water miscible solvent. The water miscible solvent is environmentally safe.

According to an embodiment, the process of preparing an organic agricultural composition in wettable powder form, comprises: milling a blend of at least one micronutrient in its elemental form or salts or complexes or derivatives thereof, at least one hydrocolloid and optionally at least one agrochemical excipient to obtain a wettable powder composition with desired particle size. However, those skilled in the art will appreciate that it is possible to modify or alter or change the process or process parameters to obtain wettable powder, without departing from the scope of the present invention.

According to an embodiment, the composition of the present invention is at least one of a pesticide composition, a crop protection composition, a fertilizer composition, a crop strengthener composition, a yield enhancer composition.

According to an embodiment, the invention also relates to a method of protecting the crop, controlling insect pest, improving the crop health and growth, improving the plant nutrition, enhancing the crop yield, strengthening the plant, increasing crop defense, the method comprising treating at least one of seed, crops, a plant, plant propagation material, locus, plant parts thereof or to the surrounding soil with effective amount of the organic agricultural composition of the present invention in the form of water dispersible granules or spheronised granules, suspension or wettable powder.

The composition is applied through a variety of methods. Methods of applying to the soil include any suitable method, which ensures that the composition penetrates the soil, for example nursery tray application, in furrow application, soil drenching, soil injection, drip irrigation, sprinkler irrigation, seed treatment, seed painting and such other methods. The composition can also be applied in the form of a foliar spray.

The rates of application or the dosage of the composition depends on the type of use, the type of crops, or the specific active ingredients in the composition but is such that the active ingredient, is in an effective amount to provide the desired action (such as crop nutrition, crop protection, crop yield).

From the foregoing it will be observed that numerous modifications and variations can be effectuated without departing from the true spirit and scope of the novel concepts of the present invention. It is to be understood that no limitation with respect to the specific embodiments illustrated is intended or should be inferred.

### A. PREPARATION EXAMPLES

The following examples illustrate the basic methodology and versatility of the composition of the invention. Hydrocolloid exemplified in the preparatory examples can be replaced by any other hydrocolloid thereof. It should be noted that this invention is not limited to these exemplifications.

### A. Water Dispersible Granular Composition of at Least One Micronutrient and Hydrocolloid

### Example 1: Water Dispersible Granular Composition of 95% w/w Zinc Oxide and 5% w/w Gum Ghatti

Water dispersible granular composition was prepared by blending 95 parts of Zinc oxide, and 5 parts of gum ghatti to obtain a blend. The blend obtained was mixed with water in suitable mixing equipment and milled to form a slurry or wet mix.

The wet milled slurry obtained was spray dried at an inlet temperature less than 150° C. and outlet temperature less than 70° C. to get a granular powder. The composition had the following particle size distribution: D10 less than 0.5 microns; D50 less than 2 microns and D90 less than 3 microns. The granule size of the composition was in the range of 0.1-2.5 mm. The composition had dispersibility of 81.1%, suspensibility of 83.7%, wet sieve retention value of 0.05, wettability of less than 5 sec. The composition further demonstrated dispersibility of 79.4% and suspensibility of about 81.4% under accelerated storage condition.

### Example 2: Soluble Granule Composition of Boric Acid 80% w/w and Gum Arabic 8% w/w

Soluble granule composition was prepared by dispersing 8 parts of gum arabic in water and allowing it to form a translucent dispersion, followed by the addition of 80 parts of boric acid. The dispersion was homogenized with a suitable homogenizer, milled and spray dried to obtain a soluble granule.

The composition had the following particle size distribution: D10 less than 0.5 microns; D50 less than 2 microns and D90 less than 3 microns. The granule size of the composition was in the range of 0.1-2.5 mm. The composition had dispersibility of 97.5%, suspensibility of 99.3%. The composition further demonstrated dispersibility of 95.6% and suspensibility of about 96.8% under accelerated storage condition.

### Example 3: Soluble Granule Composition of Selenium Dioxide 20% w/w and Gum Arabic 15% w/w with Sodium Sulphate and Fulvic Acid

Soluble granule composition was prepared by dispersing 15 parts of gum arabic in water and allowing it to form a translucent dispersion, followed by the addition of 20 parts of selenium dioxide. The dispersion was homogenized with a suitable homogenizer followed by addition of sodium sulphate and fulvic acid to form a clear dispersion and spray dried to obtain a soluble granule.

The composition had the following particle size distribution: D10 less than 0.5 microns; D50 less than 2 microns and D90 less than 3 microns. The granule size of the composition was in the range of 0.1-2.5 mm. The composition had dispersibility of 96.5%, suspensibility of 98.3%. The composition further demonstrated dispersibility of 92.3% and suspensibility of about 95.2% under accelerated storage condition.

The exemplary combination of the water dispersible granular composition prepared as per example 1 is tabulated below:

| | | Conc. | | | | | | | |
|---|---|---|---|---|---|---|---|---|---|
| | | micro- | | | | | | Excip- | |
| Ex. | | nutrient | Conc. of Hydrocolloid (%) | | | | | ient | Excipient |
| no. | Micronutrient | (% w/w) | GA | GK | GG | NG | MG | (% w/w) | (% w/w) |
| 4 | Zinc Oxide | 20 | — | 16 | — | — | — | 64 | Fulvic acid 5%, |
| | | | | | | | | | Lactose 25%, |
| | | | | | | | | | Clay 34% |
| 5 | Manganese | 90 | — | — | 10 | — | — | — | — |
| | oxide | | | | | | | | |
| 6 | Manganese | 20 | 16 | — | — | — | — | 64 | Maltodextrin 10%, |
| | oxide | | | | | | | | Starch 20%, |
| | | | | | | | | | China clay 33%, |
| | | | | | | | | | Silica 1% |
| 7 | Cuprous oxide | 92 | — | — | 8 | — | — | — | — |
| 8 | Cuprous oxide | 20 | — | — | — | 16 | — | 64 | Glucose 10%, |
| | | | | | | | | | Talc 5%, |
| | | | | | | | | | Starch 33% |
| | | | | | | | | | Dextrin 16% |
| 9 | Molybdenum | 92 | — | — | 8 | — | — | — | — |
| | disulphide | | | | | | | | |
| 10 | Molybdenum | 20 | — | — | — | — | 16 | 64 | Fulvic acid 8%, |
| | disulphide | | | | | | | | Soapstone 10%, |
| | | | | | | | | | Clay 20%, |
| | | | | | | | | | Sodium chloride 6%, |
| | | | | | | | | | Lactose 20% |
| 11 | Red Iron oxide | 92 | 8 | — | — | — | — | — | — |
| 12 | Red Iron oxide | 20 | — | — | 16 | — | — | 64 | Starch 50%, |
| | | | | | | | | | Fulvic acid 14% |
| 13 | Zinc borate | 80 | 20 | — | — | — | — | — | — |
| 14 | Zinc borate | 20 | — | — | 8 | — | — | 82 | Starch 28%, |
| | | | | | | | | | Bentonite 6%, |
| | | | | | | | | | Lactose 48% |
| 15 | Vanadium | 20 | 15 | — | — | — | — | 35 | Maltodextrin 10%, |
| | pentoxide | | | | | | | | Soapstone 5%, |
| | | | | | | | | | Clay 20% |
| 16 | Vanadium | 20 + 70 | 10 | — | — | — | — | — | — |
| | pentoxide + | | | | | | | | |
| | Manganese | | | | | | | | |
| | oxide | | | | | | | | |
| 17 | Ferric oxide + | 30 + | 10 | — | 10 | — | — | — | — |
| | boric acid + | 30 + | | | | | | | |
| | Zinc oxide | 20 | | | | | | | |

| | Particle size | | | | | ATS | |
|---|---|---|---|---|---|---|---|
| Ex. | distribution | | | SS | DP | SS | DP |
| no. | D10 | D50 | D90 | (%) | (%) | (%) | (%) |
| 4 | 0.08 | 1.3 | 2.7 | 97.4 | 92.4 | 95.4 | 91.4 |
| 5 | 0.5 | 4.0 | 7.6 | 85.2 | 82.6 | 84.2 | 80.6 |
| 6 | 0.17 | 1.7 | 3.5 | 95.2 | 91.8 | 93.8 | 90.1 |
| 7 | 0.7 | 5.2 | 10.1 | 83.1 | 80.5 | 81.3 | 78.5 |
| 8 | 0.15 | 1.7 | 3.6 | 90.7 | 88.9 | 88.4 | 85.9 |
| 9 | 0.4 | 2.9 | 6.3 | 88.3 | 81.6 | 85.9 | 78.6 |
| 10 | 0.09 | 1.4 | 2.5 | 96.4 | 93.7 | 90.1 | 88.9 |
| 11 | 0.08 | 1.2 | 2.5 | 80.6 | 81.5 | 76.6 | 73.5 |
| 12 | 0.09 | 1.4 | 2.7 | 75.2 | 93.6 | 70.6 | 90.6 |
| 13 | 0.08 | 2.4 | 5.92 | 93.5 | 87.6 | 91.7 | 84.2 |
| 14 | 0.08 | 1.5 | 3.1 | 98.9 | 95.6 | 93.7 | 92.1 |
| 15 | 0.07 | 1.21 | 2.48 | 100 | 98.5 | 98.1 | 92.8 |
| 16 | 0.2 | 3.6 | 7.5 | 85.2 | 83.6 | 80.6 | 79.2 |
| 17 | 0.4 | 3.7 | 8 | 83.5 | 81.6 | 81.9 | 78.1 |

GA = Gum arabic,
GK = Gum karaya;
GG = Gum Ghatti;
NG = Neem Gum;
MG = Moringa Gum;
SS = Suspensibility;
DP = Dispersibility;
ATS: Accelerated Storage Conditions

### B. Liquid Suspension Compositions of Micronutrient and Hydrocolloid

### Example 18: Liquid Suspension Composition of 40% Zinc Oxide and 10% Gum Arabic

Liquid suspension composition was prepared by mixing 40 parts of zinc oxide, 10 parts of gum arabic, 10 parts of glycerol, 0.1 parts xanthan gum, 1 parts of sodium benzoate and water (quantity sufficient) and homogenized by feeding them into a vessel provided with stirring facilities until the total mixture was homogeneous. Subsequently, the suspension obtained was passed through the wet mill to obtain a suspension concentrate with a particle size of less than 20 microns. The composition had particle size distribution of about D10 less than 1 microns; D50 less than 2 microns and D90 less than 4 microns. The sample had suspensibility of about 85.5, viscosity of about 350 cps. The composition had suspensibility of about 80.2 and viscosity of about 280 cps under accelerated storage condition.

The exemplary combination of liquid suspension composition prepared as per example 18 is tabulated below:

| | Conc. of | | | | | | Excipient (%) | | | | Particle size | | | | | ATS | |
|---|---|---|---|---|---|---|---|---|---|---|---|---|---|---|---|---|---|
| Ex. | micro- | Conc. of Hydrocolloid (%) | | | | | | Xanthan | Sodium | | distribution | | | SS | VC | SS | VC |
| no. | nutrient (%) | GA | GK | GG | NG | MG | Glycerol | gum | benzoate | Water | D10 | D50 | D90 | (%) | (cps) | (%) | (cps) |
| 19 | Manganese | — | — | 4 | — | — | 10 | 0.1 | 1.0 | Q.S. | 0.2 | 1.4 | 3 | 87.2 | 275 | 84.7 | 215 |
| | Oxide 40% SC | | | | | | | | | | | | | | | | |
| 20 | Red Iron | 10 | — | — | — | — | 10 | 0.1 | 1.0 | | 0.3 | 1.8 | 3.7 | 89.4 | 450 | 86.0 | 435 |
| | oxide 30% SC | | | | | | | | | | | | | | | | |

GA = Gum arabic,
GK = Gum karaya;
GG = Gum Ghatti;
NG = Neem Gum;
MG = Moringa Gum
SS = Suspensibility;
DP = Dispersibility;
VC: Viscosity;
Q.S.: quantity sufficient;
ATS: Accelerated Storage Conditions

### C. Wettable Powder Compositions of Micronutrient and Hydrocolloid

### Example 21: Wettable Powder (WP) Composition of 50% Zinc Oxide and 5% Gum Arabic

Wettable powder was prepared by mixing 50 parts of zinc oxide, 5 parts of gum arabic, 20 parts of fulvic acid, 0.5 parts of Quillaija bark extract and 24.5 parts of clay to obtain a dry mix. The obtained dry mix was passed through the air jet mill to obtain wettable powder. The obtained wettable powder composition has particle size distribution of D(10) of 1.5 microns, D(50) of 7.6 microns and D(90) of 14.8 microns, a suspensibility of 74%, wettability of 10 seconds, wet sieve retention of 0.12%, and a pH of 6.2

Bio-Efficacy Data:

To study effect of organic agrochemical composition of at least one micronutrient and at least one hydrocolloid according to an embodiment of the present invention:

Lab Trial Experiment No. 1: Trial was conducted for the evaluation of the effect of the composition of the present invention on beneficial bacterial and fungal strains in soil for Azotobacter sp., and Trichoderma viride at different concentrations of the composition.

The sterile soil was inoculated with beneficial bacterial and fungal strains in soil for Azotobacter sp., and Trichoderma viride and treated with the composition of the present invention and conventional micronutrient formulation prepared by using lignin sulphonate as dispersing agent.

TABLE 3
Effect of the organic agricultural composition of the present invention
on the beneficial bacterial and fungal strains in soil.

| | | | Cell Population (CFU/gm) | | | | | |
|---|---|---|---|---|---|---|---|---|
| | | Micronutrient | Azotobacter sp. | | | Trichoderma viride | | |
| T. | | salt applied | | | % | | | % |
| no. | Composition | (g.a.i/acre) | Day 1 | Day 7 | Change | Day 1 | Day 7 | Change |
| T1 | Zinc Oxide | 950 | 2.5 × 10⁷ | 3 × 10⁷ | 20 | 2.1 × 10⁷ | 2.9 × 10⁷ | 38.09 |
| | 95% w/w + | | | | | | | |
| | Gum arabic | | | | | | | |
| | 5% w/w | | | | | | | |
| | WDG as per | | | | | | | |
| | embodiment | | | | | | | |
| | of the present | | | | | | | |
| | invention @ | | | | | | | |
| | 1 Kg/acre | | | | | | | |
| T2 | Conventional | 950 | 2.6 × 10⁷ | 3 × 10⁷ | 15.4 | 2.1 × 10⁷ | 2.7 × 10⁷ | 28.5 |
| | Zinc oxide | | | | | | | |
| | 95% w/w | | | | | | | |
| | WDG @ | | | | | | | |
| | 1 Kg/acre | | | | | | | |
| T3 | Manganese | 200 | 3.1 × 10⁷ | 3.6 × 10⁷ | 16.12 | 3.2 × 10⁷ | 3.6 × 10⁷ | 12.5 |
| | oxide | | | | | | | |
| | 4% w/w + | | | | | | | |
| | Gum Ghatti | | | | | | | |
| | 4% w/w | | | | | | | |
| | WDG as per | | | | | | | |
| | embodiment | | | | | | | |
| | of the present | | | | | | | |
| | invention@ | | | | | | | |
| | 5 Kg/acre | | | | | | | |
| T4 | Conventional | 200 | 3 × 10⁷ | 3.3 × 10⁷ | 10 | 3.2 × 10⁷ | 3.5 × 10⁷ | 6.06 |
| | manganese | | | | | | | |
| | oxide | | | | | | | |
| | 4% w/w | | | | | | | |
| | WDG | | | | | | | |
| | prepared | | | | | | | |
| | using lignin | | | | | | | |
| | sulphonate as | | | | | | | |
| | dispersing | | | | | | | |
| | agent @ | | | | | | | |
| | 5 Kg/acre | | | | | | | |
| T5 | Untreated | — | 2 × 10⁷ | 2.1 × 10⁷ | 5 | 3.3 × 10⁶ | 3.3 × 10⁶ | 0 |

It was noted that treatments T1 and T3 appeared to better support the growth of Trichoderma viride and Azotobacter sp. in soil as compared to the conventional Zinc oxide 95% w/w WG (T2) and Manganese oxide 4% w/w WDG (T4) formulation prepared by using lignin sulphonate as dispersing agent.

Thus, the organic agricultural composition of the present invention in the form of water dispersible granules supports the growth of beneficial microorganisms.

Field Trial Data 1: To Study Effect of Micronutrients and Hydrocolloids on Tomato and Sugar Cane

The effectiveness of combination of micronutrient with hydrocolloids was evaluated in the form of water dispersible granules (WDG) and suspension concentrates (SC), in comparison to application of commercially available or conventional micronutrient formulations and an untreated control.

The efficacy trials conducted in India using recommended dosages for active ingredients. However, it may be noted that the recommended dosages for each active ingredient may vary as per recommendations in a particular country, soil condition, weather condition and crop requirement. The treatments were carried out following randomized block design (RBD) and keeping all agronomic practices uniform.

The field trials were carried out to see the effect of combination of micronutrient and hydrocolloids on Tomato and Sugar cane. The trial was laid out as described below including untreated control, and replicated four times. The crops in trial field was raised following good agricultural practice.

| Details of experiment | Tomato | Sugarcane |
|---|---|---|
| Trial Location | Adgoan, Nasik (MH) | Navsari, Gujarat |
| Experiment season | Kharif | Kharif |
| Trial Design | RBD | RBD |
| Replications | 04 | 04 |
| Treatments | 06 | 06 |
| Plot size | 40 m² | 50 m² |
| Method of application | Foliar application | Basal application |

TABLE 4
Effect of combination of micronutrient and hydrocolloid
on Fruit yield, shelf life in Tomato

| | | Elemental | Fruit | % yield | |
|---|---|---|---|---|---|
| Treat- | | Micronutri- | Yield | increase | Shelf |
| ment | | ent applied | (q/ | over un- | life |
| No. | Composition | (g.a.i/acre) | acre) | treated | (Days) |
| 1 | Elemental Boron | 48 | 367 | 18.39 | 13.40 |
| | 16% w/w (Di-sodium | | | | |
| | octaborate | | | | |
| | tetrahydrate) + Gum | | | | |
| | Arabic 20% w/w SG | | | | |
| | as per an embodiment | | | | |
| | of the invention @ | | | | |
| | 300 g/acre | | | | |
| 2 | Elemental Boron (Di- | 48 | 342.1 | 10.35 | 10.20 |
| | sodium octaborate | | | | |
| | tetrahydrate) 20% | | | | |
| | w/w (Probor ® | | | | |
| | powder) @ 240 | | | | |
| | g/acre | | | | |
| 3 | Elemental Zinc | 55 | 366 | 18.06 | 11.10 |
| | 39.5% w/w (as zinc | | | | |
| | oxide) + Gum Arabic | | | | |
| | 5% w/w SC as per an | | | | |
| | embodiment of the | | | | |
| | invention @ | | | | |
| | 140 g/acre | | | | |
| 4 | Elemental Zinc | 55 | 344 | 10.97 | 9.60 |
| | 39.5% w/w (as zinc | | | | |
| | oxide) (Zink-ox ® | | | | |
| | 707) SC @ 140 g/acre | | | | |
| 5 | Untreated | — | 310 | 0.00 | 7.00 |

It is observed from Table 4, that treatment 1 (T1) and treatment T3 (T3) showed improved yield of fruit and shelf life in Tomato as compared to treatments T2 and T4, and untreated control. It is to be noted that the commercially available micronutrient formulations used in the trial Zink-ox® 707 (Zinc 39.5%) SC has polycarboxylate as an essential synthetic adjuvant.

Further, Elemental Boron 16%+Gum Arabic 20% w/w SG (Treatment 1) and commercially available Elemental Boron (Di-sodium octaborate tetrahydrate) 20% w/w (Probor powder) (Treatment 2) applied to Tomato crop exhibited about 18.39% and 10.35% increase respectively in yield over the control. The composition prepared as per embodiment of the present invention showed improved yield of crop as compared to the application of commercially available Elemental Boron 20% w/w (Probor® powder) and untreated plot. Further, the composition of the present invention exhibited 7.28% increase in total yield as compared to the yield obtained on application of commercially available Elemental Boron 20% w/w (Probor® powder).

Further, Treatment 3 (T3) prepared as per embodiment of the present invention and Treatment 4 (T4) commercially available Elemental Zinc 39.5% (as zinc oxide) (Zink-ox® 707) SC applied to Tomato at a dose of 140 g/acre, exhibited about 18.06% and 10.97% increase respectively in yield over the untreated control. The composition prepared as per embodiment of the present invention showed improved yield of tomato as compared to application of commercially available elemental Zinc 39.5% (Zink-ox 707) SC formulation and untreated plot. Further, the composition of the present invention exhibited 6.4% increase in total yield as compared to the yield obtained on application of commercially available elemental Zinc 39.5% (Zink-ox 707) SC formulation.

TABLE 5
Effect of micronutrient and hydrocolloid
composition on yield in Sugarcane

| | | | Total | % yield |
|---|---|---|---|---|
| | | Micronutrient | Cane | increase |
| | | salt applied | yield | over |
| Treatment | Composition | (g.a.i/acre) | (q/acre) | untreated |
| 1 | Iron oxide 23% + | 800 | 437.8 | 16.44 |
| | Gum Ghatti | | | |
| | 16% w/w WDG | | | |
| | as per an | | | |
| | embodiment of | | | |
| | the invention @ | | | |
| | 3.47 Kg/acre | | | |
| 2 | Conventional | 800 | 409.2 | 8.83 |
| | Iron oxide 23% | | | |
| | WDG prepared | | | |
| | using lignin | | | |
| | sulphonate @ | | | |
| | 3.47 Kg/acre | | | |
| 3 | Copper sulphate | 120 | 435.1 | 15.72 |
| | 3% + Gum | | | |
| | Arabic 5% w/w + | | | |
| | insoluble solid | | | |
| | carriers WDG as | | | |
| | per an | | | |
| | embodiment of | | | |
| | the invention a | | | |
| | 4 Kg/acre | | | |
| 4 | Conventional | 120 | 411.1 | 9.34 |
| | copper sulphate | | | |
| | 3% WDG | | | |
| | prepared using | | | |
| | lignin | | | |
| | sulphonate @ | | | |
| | 4 Kg/acre | | | |
| 5 | Untreated | — | 376 | 0.00 |

It is observed from Table 5, that treatment 1 (T1) and treatment 3 (T3) showed improved yield in Sugarcane as compared to treatment T2 (T2), treatment 4 (T4) and untreated control. It is to be noted that the conventional formulations (T2 and T4) used in the trial have been prepared using lignin sulphonates and other synthetic surfactants as essential adjuvants in the composition.

Further, Iron oxide 23%+Gum Ghatti 16% w/w WDG (Treatment 1) and conventionally prepared Iron oxide 23% WDG using lignin (Treatment 2) applied to Sugarcane crop at a dose of 3.47 Kg/acre, exhibited about 16.44% and 8.83% increase respectively in yield over the control. The composition prepared as per embodiment of the present invention showed improved yield of crop as compared to the application of conventionally prepared WDG formulation and untreated plot. Further, the composition of the present invention exhibited 6.98% increase in total yield as compared to the yield obtained on application of Iron oxide 23% WDG prepared using lignin sulphonate.

Further, copper sulphate 3%+Gum arabic 5%+insoluble solid carriers w/w WDG (Treatment 3) and conventionally prepared copper sulphate 3% WDG using lignin sulphonate as dispersing agent (Treatment 4) applied to Sugarcane crop at a dose of 4 Kg/acre, exhibited about 15.72% and 9.34% increase respectively in yield over the control. The composition prepared as per embodiment of the present invention showed improved yield of crop as compared to the application of conventionally prepared WG formulation and untreated plot. Further, the composition of the present invention exhibited 5.84% increase in total yield as compared to the yield obtained on application of copper sulphate 3% WDG prepared using lignin sulphonate as dispersing agent.

TABLE 6
Effect of micronutrient and hydrocolloid composition
in a specific particle size on yield in Sugarcane

| | | | | Total | |
|---|---|---|---|---|---|
| | | Range of | Micronutri- | Cane | % yield |
| | | Particle | ent salt | yield | increase |
| Treat- | | size of the | applied | (q/ | over un- |
| ment | Composition | composition | (g.a.i/acre) | acre) | treated |
| 1 | Iron oxide 23% + | 0.1 to 20 | 800 | 437.8 | 16.44 |
| | Gum Ghatti | microns | | | |
| | 16% w/w WDG | | | | |
| | as per an | | | | |
| | embodiment of | | | | |
| | the invention @ | | | | |
| | 3.47 Kg/acre | | | | |
| 2 | Iron oxide 23% + | 20 to 50 | 800 | 420.9 | 11.94 |
| | Gum Ghatti | microns | | | |
| | 16% w/w WDG | | | | |
| | as per an | | | | |
| | embodiment of | | | | |
| | the invention @ | | | | |
| | 3.47 Kg/acre | | | | |
| 3 | Iron oxide 23% + | 50 to 100 | 800 | 415 | 10.37 |
| | Gum Ghatti | microns | | | |
| | 16% w/w WDG | | | | |
| | as per an | | | | |
| | embodiment of | | | | |
| | the invention @ | | | | |
| | 3.47 Kg/acre | | | | |
| 4 | Untreated | — | — | 376 | 0.00 |

It is observed from Table 6, that treatment 1 (T1) having particle size distribution in the range of 0.1 to 20 microns showed improved yield in Sugarcane as compared to treatment 2 (T2) having particle size range of 20-50 microns, and treatment 3 (T3) having particle size distribution in the range of 50-100 microns and untreated control.

Further, Treatment 1 having particle size of 0.1 to 20 microns; Treatment 2 having particle size of 20 to 50 microns; and Treatment 3 having particle size of 50 to 100 microns applied to Sugarcane crop at a dose of 3.47 Kg/acre, exhibited about 16.44%, 11.94% and 10.37% increase in yield respectively over the control.

Thus, it was surprisingly noted that even amongst the WDG formulations, superior efficacy was observed with WDG formulation having specific particle size distribution of 0.1 to 20 microns in comparison to WDG formulations having different particle sizes in varied ranges.

Field Trial 2: Effect of Selenium Dioxide and Gum Arabic WDG Composition on Yield in Chili

WDG of Selenium dioxide (0.01% w/w) (Elemental selenium content: 0.01%)+Gum Arabic (2% w/w)+agrochemical excipient was prepared as per embodiment of the present invention (Treatment 1) and applied (basal application) at a dose of 30 Kg/acre to Chili crop at the time of transplanting the chili plant. Chili harvest (from 5 plants Chili weight) for Treatment 1 and untreated crop was 2.290 Kg and 2.110 Kg respectively. Thus, Treatment 1 exhibited about 1.29% increase in yield respectively over the untreated control.

From the foregoing, it will be observed that numerous modifications and variations can be effectuated without departing from the true spirit and scope of the novel concepts of the present invention. It is to be understood that no limitation with respect to the specific embodiments illustrated is intended or should be inferred.

1-22. (canceled)

23. An organic agricultural composition, comprising:
at least one micronutrient in elemental form or salts or complexes or derivatives thereof; and
at least one hydrocolloid; wherein the at least one hydrocolloid has a viscosity of less than 400 cps at ≤30% (w/w) aqueous dispersion of the at least one hydrocolloid;
wherein the organic agricultural composition comprises particles in a size range of 0.1 micron to 20 microns.

24. The organic agricultural composition of claim 23, wherein the at least one micronutrient comprises at least one of zinc, iron, copper, manganese, cobalt, selenium, molybdenum, boron, vanadium, silicon in its elemental form or salts or complexes or derivatives thereof.

25. The organic agricultural composition of claim 23, wherein the at least one micronutrient comprises at least one of zinc, iron, boron or selenium in its elemental form or salts or complexes or derivatives thereof.

26. The organic agricultural composition of claim 23, wherein the at least one micronutrient comprises at least one of manganese or vanadium in its elemental form or salts or complexes or derivatives thereof.

27. The organic agricultural composition of claim 23, wherein the at least one hydrocolloid comprises Gum arabic, Gum karaya, Gum ghatti (gum dhawada), Larch gum, collagen (fish), Albizia gum, Abelmoschus gum, Bhara gum, Cashew gum, Cordio gum, Grewia gum, Hakea gum, Khaya gum, Katira gum, Kondagogu gum, Leucaena, Seed gum, Malva nut gum, Mucuna gum, Moringa gum, Neem gum, Sesbanic gum or mixture thereof.

28. The organic agricultural composition of claim 23, wherein the at least one hydrocolloid is selected from gum arabic, gum karaya, gum ghatti, moringa gum, neem gum or mixtures thereof.

29. The organic agricultural composition of claim 23, wherein the organic agricultural composition is in a form of granules, liquid suspension or wettable powder.

30. The organic agricultural composition of claim 26, wherein the organic agricultural composition is in a form of granules, and wherein the granules are water dispersible granules, spheronised granules, extruded granules, soluble granules or pellets.

31. The organic agricultural composition of claim 23, wherein the organic agricultural composition is in a form of granules; wherein the organic agricultural composition comprises the at least one micronutrient in the range of 0.001% w/w to 95% w/w of total composition and the at least one hydrocolloid in the range of 0.1% w/w to 40% w/w of total composition; wherein the at least one hydrocolloid has viscosity of less than 400 cps at 30% (w/w) aqueous dispersion of the at least one hydrocolloid.

32. The organic agricultural composition of claim 23, wherein the organic agricultural composition is in a form of liquid suspension; wherein the organic agricultural composition comprises the at least one micronutrient in the range of 0.001% w/w to 70% w/w of total composition and the at least one hydrocolloid in the range of 0.1% w/w to 30% w/w of total composition; wherein the at least one hydrocolloid has viscosity of less than 400 cps at 30% (w/w) aqueous dispersion of the at least one hydrocolloid.

33. The organic agricultural composition of claim 23, wherein the organic agricultural composition comprises a particles size distribution (D90) of less than 15 microns, and a particles size distribution (D50) of less than 10 microns.

34. The organic agricultural composition of claim 23, wherein a granule size is in a range of 0.1 mm to 6 mm.

35. The organic agricultural composition of claim 23, wherein the organic agricultural composition is in a form of granules, and wherein the granules are water dispersible granules, and wherein the water dispersible granules have a granule size in a range of 0.1 mm to 2.5 mm.

36. The organic agricultural composition of claim 23, wherein suspensibility of the organic agricultural composition is at least 30%.

37. The organic agricultural composition of claim 23, wherein dispersibility of the organic agricultural composition is at least 30%.

38. The organic agricultural composition of claim 23, further comprising at least one additional active ingredient selected from biostimulants, plant growth regulator, pesticidal actives and/or fertilizer or mixtures thereof.

39. The organic agricultural composition of claim 38, wherein the organic agricultural composition further comprises elemental sulphur in a range of 0.1% w/w to 70% w/w.

40. The organic agricultural composition of claim 23, wherein the organic agricultural composition is in a form of granules, and wherein the organic agricultural composition further optionally comprises at least one agrochemically acceptable excipient selected from wetting agents, surfactants including organic surfactants, emulsifiers, wetting agents, dispersing agents, binders or fillers or carriers or diluent, disintegrating agent, buffer or pH adjuster or neutralizing agent, antifoaming agent, anti-settling agents, anticaking agent, penetrating agent, sticking agent, tackifier, pigments, colorants, stabilizers, and mixtures thereof.

41. The organic agricultural composition of claim 23, wherein the organic agricultural composition is in a form of liquid suspension, and wherein the organic agricultural composition further optionally comprises at least one agrochemically acceptable excipient selected from structuring agent, surfactants including organic surfactants, humectants, solvents, water miscible solvents, spreading agent, suspending agents or suspension aid or anti-settling, penetrating agent, sticking agents, drift reducing agents, preservatives, stabilizers, buffers or pH adjusters or neutralizing agents, antifreezing agent or freeze point depressants, antifoaming agents.

42. A process of preparing the organic agricultural composition of claim 23, wherein the organic agricultural composition is in a form of water dispersible granules, the process comprising:
a. milling a blend of the at least one micronutrient in elemental form or salts or complexes or derivatives thereof, water and the at least one hydrocolloid to obtain a slurry or wet mix with a particle size range of 0.1 micron to 20 microns; wherein the at least one hydrocolloid has viscosity of less than 400 cps at ≤30% (w/w) aqueous dispersion of the at least one hydrocolloid; and
b. drying the wet mix to obtain the water dispersible granules; wherein the water dispersible granules of the organic agricultural composition are in a size range of 0.1 mm to 2.5 mm.

43. A process of preparing the organic agricultural composition of claim 23, wherein the organic agricultural composition is in a form of spheronised granules, the process comprising:
a. milling a blend of the at least one micronutrient in elemental form or salts or complexes or derivatives thereof, water and the at least one hydrocolloid to obtain a slurry or wet mix with a particle size of 0.1 micron to 20 microns; wherein the at least one hydrocolloid has a viscosity of ≤400 cps at ≤30% (w/w) aqueous dispersion of the at least one hydrocolloid;
b. drying the wet mix to obtain the organic agricultural composition in a form of water dispersible granules; wherein the water dispersible granules of the organic agricultural composition are in a size range of 0.1 mm to 2.5 mm; and
c. adding water to a dry composition of step (b) to form a mixture, blending the mixture to obtain a wet mass, extruding the wet mass through an extruder to obtain extruded granules in a size range of 0.1 mm to 6 mm; or
agglomerating the wet mix or the dry composition of step (b) in an agglomerator to obtain the organic agricultural composition in a form of granules, wherein the granules are in a size range of 0.1 mm to 6 mm.

44. A process of preparing the organic agricultural composition of claim 23, wherein the organic agricultural composition is in a liquid suspension form, wherein the process comprises:
homogenizing a mixture of the at least one micronutrient in elemental form or salts or complexes or derivatives thereof, a liquid vehicle and the at least one hydrocolloid;
wherein the at least one hydrocolloid has a viscosity of less than 400 cps at ≤30% (w/w) aqueous dispersion of the at least one hydrocolloid; and
wet milling an obtained suspension to provide the organic agricultural composition with a particle size range of 0.1 micron to 20 microns.
